(19) United States
(12) Patent Application Publication
(10) Pub. No.: US 2013/0036058 A1
(43) Pub. Date: Feb. 7, 2013

(54) SYSTEMS AND METHODS FOR SECURELY PROCESSING TRANSACTIONS

(71) Applicants: Nicholas Kelly, Phoenix, AZ (US); John M. Rojewski, Glendale, AZ (US); Man M. Sugathan, Phoenix, AZ (US); James J. Tune, Gilbert, AZ (US); Daniel W. Yong, Peoria, AZ (US)

(72) Inventors: Nicholas Kelly, Phoenix, AZ (US); John M. Rojewski, Glendale, AZ (US); Man M. Sugathan, Phoenix, AZ (US); James J. Tune, Gilbert, AZ (US); Daniel W. Yong, Peoria, AZ (US)

(73) Assignee: American Express Travel Related Services Company, Inc., New York, NY (US)

(21) Appl. No.: 13/197,574

(22) Filed: Aug. 3, 2011

(51) Int. Cl. G06Q 20/00

(52) U.S. Cl. 705/67

(57) ABSTRACT

This disclosure includes a system, method, and article of manufacture for securely processing a transaction. The method may comprise performing a three factor authentication, communicating and/or generating, to a web client, a token in response to a transaction request and based upon the three factor authentication, comparing the token to a received token, and authorizing the transaction request based upon the comparing. Three factor authentication may comprise authenticating a web client to a transaction account associated with an individual, authenticating a web client to a payment network associated with the transaction account, and authenticating an individual to the transaction account based upon a biometric sample.

### BACKGROUND

1. Field

The present disclosure generally relates to transaction processing. More particularly, the present disclosure relates to systems and methods for securely processing transactions using a web client.

2. Related Art

In accordance with the Federal Trade Commission (“FTC”) definition, in general, identity theft occurs when a person uses another person's personally identifiable information (“PII”) to commit a fraud. PII may include any data that may be used to uniquely identify, locate, and/or contact an individual person. For example, PII may include a person's social security number, IP address, vehicle registration plate number, driver's license number, biometric data, transaction account numbers/codes, birthday, birthplace, passport data, and the like. Further, according to the FTC, identity theft may be classified in three broad categories such as: (1) Existing card account identity theft; (2) Existing non-card account identity theft; and (3) New account identity theft. Existing card account identity theft is fraud committed using an existing transaction account. Existing non-card account identity theft is fraud committed using checking and savings accounts, existing loans, insurance, telephone and utilities accounts, and the like. New account identity theft is fraud committed using a person's PII to obtain a new account, loan, etc.

According to a recent Javelin Identity Fraud Survey Report, 8.1 million people were victims of identity theft and identity fraud during the course of a single year (2011 Javelin Strategy & Research). Furthermore, the Department of Justice (“DOJ”) reports that identity theft related crimes cost victims $5 billion in out-of-pocket expenses, while costs to financial institutions approached $48 billion. See U.S. Department of Justice website, Justice Resource Update, Resources for Fighting Identity Theft, Regina B. Schofield, Spring 2006.

Thus, identity theft and identity theft related crimes often have staggering economic consequences. Indeed, such crimes not only cause banks and credit card companies to experience tremendous financial losses, they often have devastating impacts on the individuals whose identities are “stolen.” Indeed, a 2004 press release by the Identity Theft Resource Center (“ITRC”) found that half of the victims surveyed spent more than 100 hours repairing the damage done by identity thieves. Moreover, the mean number of hours spent repairing damage caused by identity theft totaled approximately 330 hours. See Identity Theft Resource Center Surveys and Studies, Press Release: Identity Theft: The Aftermath 2004, May 7, 2007. The same report by the ITRC noted significant emotional impacts resulting from identity theft. Specifically, 9% of the surveyed victims in 2003 and 16% of surveyed victims in 2004 reported that their personal relationships were either “on the rocks” or in fact ended as a result of identity theft. Id.

In conjunction with the rising incidence of identity theft, a variety of mobile and web-based purchasing has become popular. For example, digital or electronic wallets (“e-wallets”) may facilitate purchasing across a variety of mobile and web-based platforms. An e-wallet may comprise a variety of transaction account data stored on a mobile or web-based communication device (e.g., a smart phone), and an individual may select a transaction account from his e-wallet to complete a purchase. In response to an individual's selection of a transaction account from an e-wallet, the individual's mobile communication device may attempt (e.g., wirelessly) to provide his transaction account information (e.g., a transaction account number/code/identifier) to a merchant through, for example, a merchant website, a merchant point of sale (“POS”) terminal, etc. Thus, the individual's transaction account information is exposed (through his mobile and web-based devices) to a new form of attack. That is, an individual may now place his identity at risk through his physical transaction instrument as well as his through the use of his mobile and/or web-based devices.

Accordingly, what are needed are improved security mechanisms for protecting an individual's transaction account information, PII, and identity. More particularly, security mechanisms are needed which limit or eliminate exposure of an individual's transaction account information, PII, and/or identity to attack, but which nevertheless permit purchases in association with an individual's transaction account or accounts. Improved security mechanisms and/or protocols may mitigate or eliminate the emotional and financial impacts caused by identity theft before they occur.

### SUMMARY

The present disclosure includes a system, method, and article of manufacture for securely processing a transaction. The method may comprise performing to a web client a three factor authentication, communicating and/or generating a token in response to a transaction request and based upon the three factor authentication, comparing the token to a received token, and authorizing the transaction request based upon the comparing. Three factor authentication may comprise authenticating a web client to a transaction account associated with an individual, authenticating a web client to a payment network associated with the transaction account, and authenticating an individual to the transaction account based upon a biometric sample. The method may further comprise receiving the received token from a merchant, and communicating the token in combination with at least one of: a timestamp indicating a time at which the token was generated and a timestamp indicating a time at which the token expires. The transaction request may be declined based upon a timestamp associated with the token. The token may comprise at least one of: an alias transaction account number, a unique number, a non-unique number, a QR code, a bar code, and a random number.

### BRIEF DESCRIPTION OF THE DRAWINGS

The features and advantages of the present disclosure will become more apparent from the detailed description set forth below when taken in conjunction with the drawings. The left-most digit of a reference number identifies the drawing in which the reference number first appears.

FIG. 1 shows an exemplary system diagram in accordance with an embodiment.

FIG. 2 shows a flowchart depicting an exemplary process for securely processing a transaction.

FIG. 3 shows a flowchart depicting an exemplary process for screening an individual.

### DETAILED DESCRIPTION

The detailed description of exemplary embodiments herein makes reference to the accompanying drawings, which show the exemplary embodiments by way of illustration and their best mode. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

A system 100 for securely processing a transaction is disclosed. More particularly, system 100 securely processes a transaction to limit or eliminate exposure to an individual's transaction account information, PII, and/or identity.

In various embodiments, various components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the terms “individual”, “end user”, “buyer”, “consumer”, “customer”, and/or “cardmember” may be used interchangeably with each other, and each may mean any person, entity, machine, hardware, software and/or business alleged to be authorized to use a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

Phrases and terms similar to “transaction account” may include any account that may be used to facilitate a financial transaction.

Phrases and terms similar to “financial institution” or “transaction account issuer” or “payment network” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “financial transaction instrument,” “transaction instrument” and/or the plural form of these terms may be used interchangeably throughout to refer to a financial instrument.

As used herein, a biometric or biometric sample may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

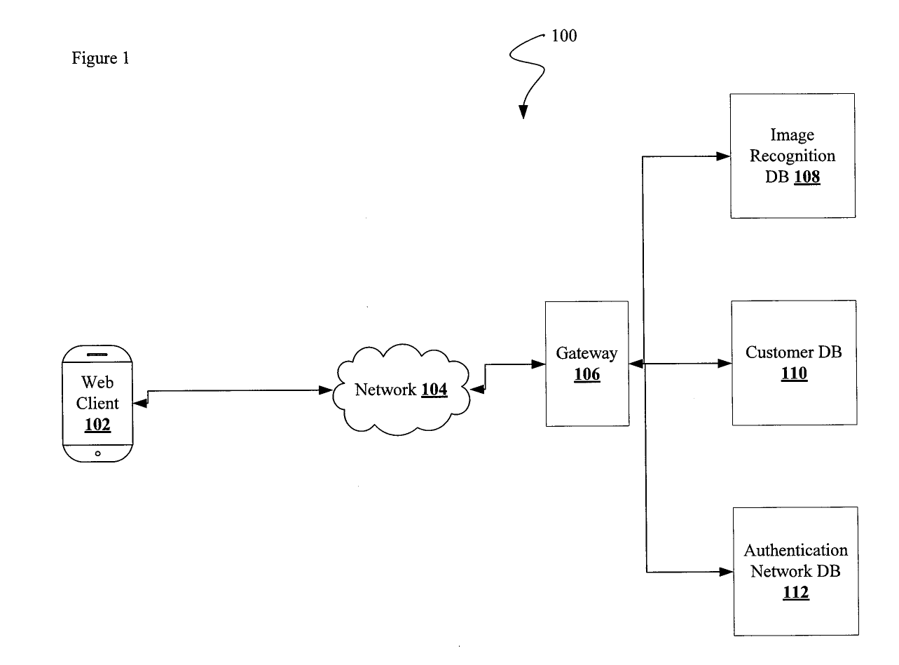

Referring to FIG. 1, an exemplary system 100 for securely processing a transaction is disclosed. In various embodiments, system 100 may securely process a transaction to limit or eliminate exposure to an individual's transaction account information, PII, and/or identity. System 100 may comprise a web client 102, a network 104, gateway 106, an image recognition database 108, a customer database 110, and/or an authentication database 112.

A web client 102 may include any device (e.g., personal computer, cellular phone, smart phone, personal digital assistant, etc.) which communicates via any network, for example such as those discussed herein. A web client may include browser applications, and these may comprise Internet browsing software installed within a computing unit or a system to conduct online transactions and/or communications. A computing unit or system may take the form of a computer or set of computers, although other types of computing units or systems may be used, including laptops, notebooks, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internet.

A web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client may include an operating system (e.g., Windows NT, 95/98/2000/CE/Mobile, OS2, UNIX, Linux, Solaris, MacOS, PalmOS, etc.) as well as a variety of conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Network 104 may include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which include, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

Gateway 106 may comprise any type of computer server configured or configurable to receive data over a network. Typically, such a server comprises a rack mountable server appliance running a suitable server operating system (e.g., IIS) and having database software (e.g., Oracle) installed thereon. Gateway 106 may facilitate communication between web client 102, image recognition database 108, customer database 110, and/or authentication network database 112.

Image recognition database 108 may comprise any type of computer server configured or configurable to host a database. Typically, such a server comprises a rack mountable server appliance running a suitable server operating system (e.g., IIS) and having database software (e.g., Oracle) installed thereon. Image recognition database 108 may store a biometric sample associated with an individual (e.g., a digital photograph or image of the individual's facial features).

Customer database 110 may comprise any type of computer server configured or configurable to host a database. Typically, such a server comprises a rack mountable server appliance running a suitable server operating system (e.g., IIS) and having database software (e.g., Oracle) installed thereon. Customer database 110 may store information associated with one or more individuals. For example, customer database 110 may store PII associated with one or more individuals. That is, for example, customer database 110 may store individual names, birth dates, transaction account data (e.g., transaction account numbers and/or codes), phone numbers, security questions and/or answers to security questions, biometric samples, and the like.

Authentication network database 112 may comprise any type of computer server configured or configurable to host a database. Typically, such a server comprises a rack mountable server appliance running a suitable server operating system (e.g., IIS) and having database software (e.g., Oracle) installed thereon. Authentication network database 112 may store authentication information associated with one or more individuals, one or more web clients 102, and/or one or more payment networks.

For example, authentication network database 112 may store one or more public encryption keys associated with an individual, a web client 102, and/or a payment network. The one or more public encryption keys may be used as part of a public key infrastructure (“PKI”) to authenticate one or more individuals, web clients 102, and/or networks. For example, authentication network database 112 may store a public key associated with a web client 102. The web client 102 (or individual) may be authenticated (e.g., to ensure that the web client 102 is not a spoofed device) provided the web client 102 stores the corresponding private key and is able to sign a challenge using this private key. Likewise, authentication network database 112 may store a public key associated with a particular network (e.g., a transaction account issuer network, such as the American Express payment network). The web client 102 (or individual) may be authenticated (e.g., to confirm that the web client 102 is in fact associated with a particular payment network) to the payment network provided the web client 102 stores the corresponding private key and is able to sign a challenge using this private key. It may be desirable to confirm that a web client 102 is associated with a particular payment processor for loss distribution purposes. That is, for example, it may be desirable to confirm that a web client 102 is associated with the American Express payment network to ensure that fraudulent transactions, should they occur by way of the web client 102, are properly charged to American Express.

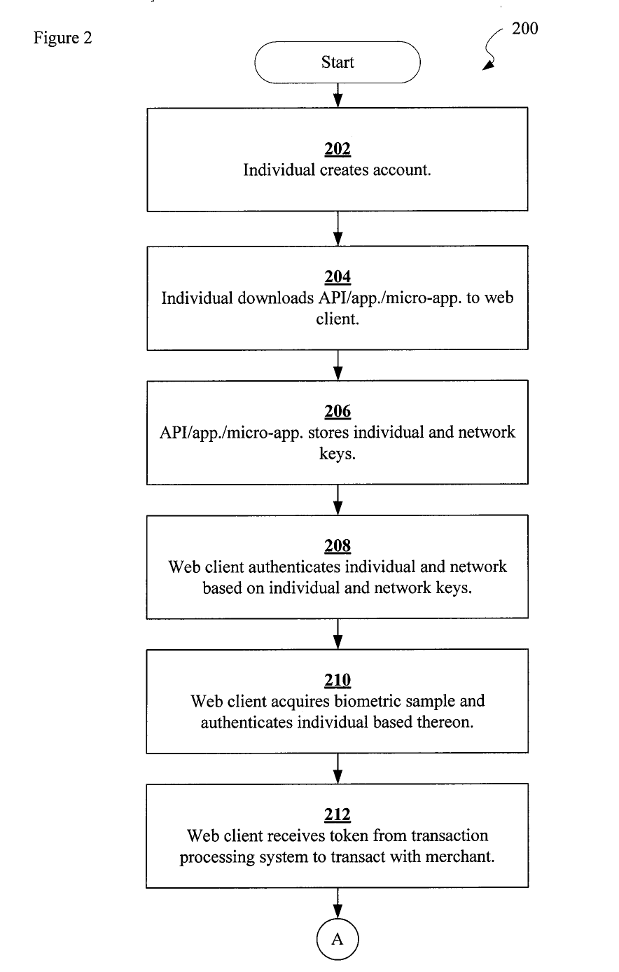

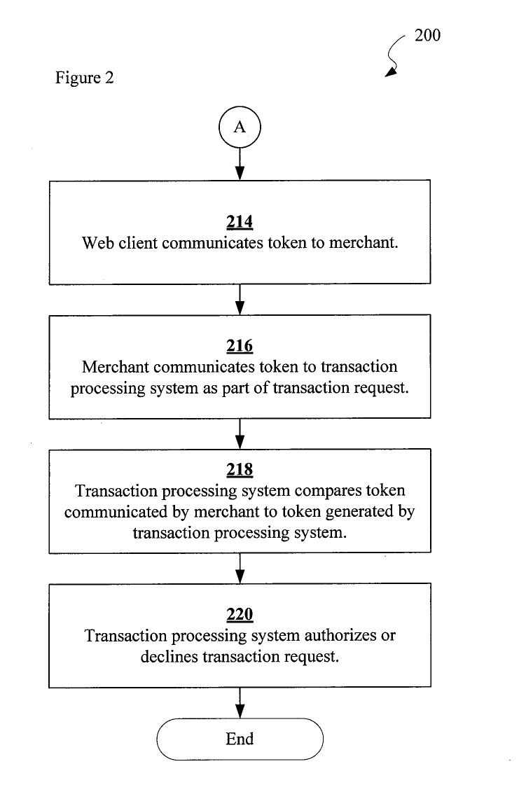

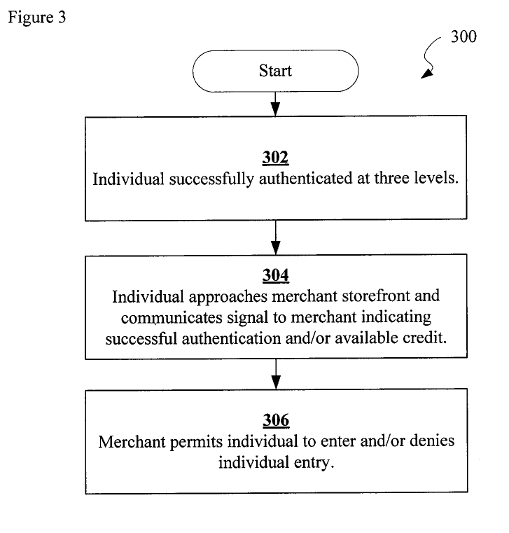

Referring now to FIGS. 2-3 the process flows and screenshots depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 2-3, but also to the various system components as described above with reference to FIG. 1.

With reference to FIG. 2, a process 200 for securely processing a transaction is disclosed. The process 200 may facilitate, as described above, mobile and/or web-based transactions. That is, for example, process 200 may facilitate secure “cashless” and/or “cardless” mobile and/or web-based transactions. Accordingly, in order to take advantage of process 200, an individual may create an account with a transaction account issuer (step 202). An individual may create an account by way of a transaction account issuer website, where the individual may enter a variety of information, including the individual's name, birth date, transaction account number or numbers, telephone number or numbers, one or more biometric samples, security questions, answers to security questions, and the like.

On receipt of the individual's information by system 100 (e.g., customer database 110) the individual may download, to his web-client 102, one or more application programming interfaces (“APIs”), one or more applications, and/or one or more micro-applications (step 204). The one or more APIs, one or more applications, and/or one or more micro-applications may store, include, or accompany one or more encryption keys (e.g., one or more public encryption keys) (step 206).

For example, system 100 (e.g., authentication network database 112) may generate and/or store a public and private key pair, and this pair may be uniquely associated with the individual's web client 102 (and/or the individual). This key pair may be referred to as an “individual key pair.” Likewise, the public and private keys may be referred to as the “individual public key” and the “individual private key,” respectively. The individual key pair may, for example, be uniquely associated with the individual's web client 102 by way of the telephone number provided by the individual above and/or a media access control (“MAC”) address associated with the user's web client 102. The individual's web client 102 may store the individual public key, while customer database 110 and/or authentication network database 112 store the corresponding individual private key.

Similarly, system 100 (e.g., authentication network database 112) may generate and/or store a public and private key pair, and this pair may be uniquely associated with the payment network/transaction account issuer (e.g., American Express) that issued the individual's transaction account and/or the individual's web client 102 and/or another data record associated with the individual. This key pair may be referred to as a “network key pair,” and the public and private keys in this pair may be referred to as the “network public key” and the “network private key,” respectively. The network key pair may, for example, be uniquely associated with the individual's web client 102 (or the individual), as described above, by way of the telephone number and/or MAC address provided by the individual. Likewise, the network key pair may be uniquely associated with the payment network/transaction account issuer by virtue of the fact that the payment network/transaction account issuer holds the network private key.

Thus, web client 102 may store (e.g., via an API, application, and/or micro-application) an individual public key and a network private key. An individual may authenticate his web client 102 to a transaction account using one or more of the individual and network public keys (step 208). That is, an individual may authenticate his web client 102 using the individual public key, where system 100 may (together with network authorization database 112) issue a challenge using the individual private key stored by the network authorization database 112. If web client 102 signs the challenge with the corresponding individual public key, system 100 may authenticate the individual/the individual's web client 102. System 100 may thus verify, at least, that the web client 102 is properly associated with an individual's transaction account.

An individual and/or web client 102 may authenticate to a payment network in like manner. That is, an individual may authenticate his web client 102 using the network public key, where system 100 may, together with network authorization database 112, issue a challenge using the network private key stored by the network authorization database 112. If web client 102 signs the challenge with the corresponding network public key, system 100 may authenticate the individual and/or the individual's web client 102. System 100 may thus verify, at least, that the web client 102 is properly associated with the payment network. As described above, it may be advantageous to authenticate an individual and/or web client 102 to a payment network to ensure, in the event of fraud, that the payment network shares properly in any losses incurred as a result thereof.

Thus, system 100 may verify, first, that a web client 102 is properly associated with an individual's transaction account, and second, that a web client 102 is properly associated with a payment network. However, a third layer or level of authentication may be advantageous, particularly where the individual loses or is dispossessed of his web client 102 by an identity thief. That is, without an additional layer of security, web client 102 may successfully authenticate at both the individual and network levels in the hands of an identity thief.

Accordingly, web client 102 may acquire a biometric sample of the individual as part of a third layer or level of security (step 210). Web client 102 may forward or transmit an encrypted or unencrypted version of the biometric sample to image recognition database 108, which may authenticate the individual (step 210). Web client 102 may, in addition, score a biometric sample based upon one or more scoring algorithms. Scoring may comprise, in various embodiments, sampling the biometric sample (e.g., at a variety of preselected data points or based upon a specified sampling technique). Image recognition database 108 may authenticate an individual based upon the scored version of the biometric sample transmitted by web client 102 and/or based upon a raw biometric sample. Image recognition database 108 may, in various embodiments, score a biometric sample. An individual may be authenticated based upon his biometric sample if the sample or a scored version of the sample is within an acceptable tolerance. That is, an individual may be authenticated if his raw or scored biometric is similar enough (based on a comparison) to an earlier raw or scored (e.g., on account creation at step 202) version of his biometric sample. If authentication fails, system 100 may attempt to reacquire and/or rescore the individual's biometric sample.

Thus, an individual may be authenticated, and this process may thwart the efforts of any identity thief attempting to use an individual's web client 102 to make an unauthorized purchase. In response to a successful three factor authentication (i.e., authentication of the individual key, the network key, and the biometric sample), a “token” or “one time password (‘OTP’)” may be transmitted to the web client 102 (step 212) by system 100 and/or a transaction processing system (not shown), which may be operatively and/or communicatively coupled to system 100. That is, a token may be generated by system 100 and/or by another transaction processing system (not shown), which may be operatively and/or communicatively coupled to system 100.

In an embodiment, a token, OTP and/or authorization code may be sent by a transaction processing system and/or system 100 to a merchant (e.g., on a known established secure network). This may occur in addition to and/or in place of a token and/or OTP being sent to web client 102. Where a merchant receives such an authorization (e.g., a token, an OTP, an authorization code), the merchant may be additionally sent a biometric score to validate with the individual purchaser's web client 102 (since the individual purchaser may have just previously transmitted their biometric to transaction processing system and/or system 100 making it available for transmission to a merchant). In effect, transmission of the authorization to a merchant may operate to synchronize a specific purchaser with an authorization (e.g. token, OTP, authorization code) held by the merchant. Thus, the authorization (e.g. token, OTP, authorization code) may be prevented from being exposed outside of the secure communication channel between the merchant and the transaction processing system and/or system 100. An individual purchaser may transmit (e.g., share) his biometric for validation with a merchant by way of any mechanism discussed herein (e.g., through a scan, wirelessly, a QR Code, and/or any other mechanism). Further, a time sensitive expiration may be applied to this type of authorization. For example, a purchaser may have a certain time frame to complete a transaction with web client 102. Otherwise, a transaction may be rejected or invalidated for any further processing.

A token or OTP may comprise an alias transaction account number and/or any other (unique or non-unique) number, code, alphanumeric string, etc. That is, a token may comprise any identifier or code, but it may not, in various embodiments, comprise any PII (e.g., an actual transaction account number) associated with an individual. Thus, a token may not be derived by an identity thief or spoofed based upon information associated with an individual (e.g., an individual's PII). Rather, a token may comprise a randomly generated number, code, or identifier which may function, as described below, to signify a satisfactory/complete/successful three factor authentication.

An individual may receive a token, as indicated above, in response to a successful three factor authentication. An individual may, in addition, receive a token in response to a token request by the individual, or the individual's web client 102), for a token. A token request may be accompanied by, or one and the same with, a transaction request. For instance, an individual may locate an item or items that he wishes to purchase and acquire (e.g., scan, manually enter, photograph, receive wirelessly, receive via a wired connection, etc.) an item code for the item or items using his web client 102. An item code may include a variety of information about an item or items—e.g., one or more item descriptions, a total transaction request amount, a merchant identifier, and the like. Thus, an individual may acquire an item code, transmit the item code as part of a transaction request to a payment network, and receive a token in response. The payment network may generate a token provided the individual has satisfactorily completed a three factor authentication process, as described above. In addition, the payment network may generate a token (or decline to generate a token) based upon a variety of business rules—e.g., the individuals' available credit, the likelihood that the transaction request is fraudulent, etc.

On receipt of a token, web client 102 may communicate the token to the merchant from whom the individual wishes to make a purchase (step 214). Web client 102 may communicate a token in several ways. For instance, web client 102 may communicate a token to a merchant POS terminal and/or another merchant system using a wireless transfer protocol (e.g., Bluetooth®, Wifi, etc.) Web client 102 may further communicate a token to a merchant system over a wired (internet, network, etc) connection. Further still, web client 102 may communicate a token to a merchant system by displaying a quick response (“QR”) code, a bar code, another code comprising the token, and/or the token itself. In this regard, a merchant or merchant system may scan the code or token displayed by the web client 102 and/or manually enter the code or token in order to retrieve and/or decode the token.

A merchant or a merchant system may (e.g., on receipt of a token or a code comprising a token) communicate the token or encoded token to system 100 and/or a transaction processing system (not shown) as part of a transaction request (step 216). System 100 and/or the transaction processing system may compare the token received from the merchant (“received token”) and/or code comprising the received token to the token and/or code comprising the token (step 218). That is, a comparison between the token transmitted to web client 102 and the received token may be performed. Where the token and received token (or codes comprising the token and received token) match or are the same, a transaction request may be authorized and the received token validated (step 220). Likewise, where the token and received token or codes comprising the token and received token do not match or are not the same, a transaction request may be declined (step 220).

In various embodiments, a token may be associated with a timestamp representing, for example, a time at which the token was generated and/or a time at which the token expires. System 100 and/or another transaction processing system may authorize or decline a transaction, as described above, based upon a comparison between the transmitted and received tokens, but also upon the timestamp. That is, although a received token may match a transmitted token, a transaction request may nevertheless be declined based upon a timestamp. For instance, a token may be associated with a particular timestamp and valid for a particular duration. Where the token is received from a merchant at a time later than the timestamp plus the duration, even if it matches the token transmitted to web client 102, a transaction may be declined. Similarly, a token may be associated with an expiration timestamp. Where the token is received from a merchant at a time later than the expiration timestamp, a transaction request may be declined even though the received token matches the token transmitted to web client 102.

Thus, a web client 102 may be used as part of a process for securely processing a transaction. A three factor authentication process may be used to ensure that a web client 102/individual is properly associated with an individual's transaction account, that the web client 102/individual is properly associated with a payment network, and that the individual is properly associated with his web client 102. A token may be transmitted to the individual's web client 102, which a merchant system may receive and communicate to system 100 and/or a transaction processing system. System 100 and/or the transaction processing system may validate that token supplied by the merchant and approve a transaction request submitted by the merchant and with the token. An individual may thus safely and securely engage in a cardless, cashless purchasing process using his web client 102 as an e-wallet.

In various embodiments, process 200 may be implemented in a checkerless or fully automated merchant location. That is, process 200 may obviate the need for checkers at a merchant location. An individual may, for example, enter a merchant location, select an item for purchase, and communicate, by way of the merchant system (e.g., a merchant POS terminal) or by way of the individual's web client 102 (which may include a bar code scanner, for example), a transaction request to a transaction processing system/system 100. As described above, the individual's web client 102 may communicate a token to the individual's web client 102, which the merchant system may acquire and communicate to system 100 and/or the transaction processing system, at which point the transaction request may be approved or declined. It may be unnecessary in this example to employ checkers at the merchant location, because the security afforded by process 200 obviates the necessity to check an individual's identification (e.g., the individual's driver's license) in association with the individual's proffered transaction instrument. Thus, the systems and methods described herein may facilitate the operation of a checkerless merchant location.

With reference to FIG. 3 process 200 may be further utilized by a merchant to screen individuals. For instance, a merchant may detect a signal (e.g., a low frequency digital signal) transmitted by an individual's web client 102. This signal may broadcast a variety of information, including whether the individual has satisfied a three factor authentication requirement, as described above, as well as whether the individual has sufficient credit to purchase from the merchant (steps 302 and 304). In a web-based environment, a merchant may perform a similar screening, but based upon a signal communicated over a network (e.g., the interne) by the individual's web client 102. A merchant may make a decision to deny or permit an individual entry to the merchant location and/or the merchant website based upon the information communicated to the merchant by web client 102 (step 306). That is, for example, an individual who has not satisfied a three factor authentication requirement and/or an individual who is not associated with a web client 102 (e.g., an indigent individual) may be denied entry to a merchant location, while an individual who has satisfied a three factor authentication requirement and/or who has credit sufficient to make a purchase may be allowed entry.

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems, methods and computer program products are provided. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers. A user may include any individual, business, entity, government organization, software and/or hardware that interact with a system.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

Phrases and terms similar to an “item” may include any good, service, information, experience, data, content, access, rental, lease, contribution, account, credit, debit, benefit, right, reward, points, coupons, credits, monetary equivalent, anything of value, something of minimal or no value, monetary value, non-monetary value and/or the like.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.\

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in various embodiments, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, and symmetric and asymmetric cryptosystems.

Firewall may include any hardware and/or software suitably configured to protect CMS components and/or enterprise computing resources from users of other networks.

Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In various embodiments, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In various embodiments, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

In yet another embodiment, the transponder, transponder-reader, and/or transponder-reader system are configured with a biometric security system that may be used for providing biometrics as a secondary form of identification. The biometric security system may include a transponder and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric.

Phrases and terms similar to an “entity” may include any individual, consumer, customer, group, business, organization, government entity, transaction account issuer or processor (e.g., credit, charge, etc), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

The system may include or interface with any of the foregoing accounts or devices, a transponder and reader in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “payment processor” may include a company (e.g., a third party) appointed (e.g., by a merchant) to handle transactions for merchant banks. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction. Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

Phrases similar to “vendor software” or “vendor” may include software, hardware and/or a solution provided from an external vendor (e.g., not part of the merchant) to provide value in the payment process (e.g., risk assessment).

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should be construed to exclude only those types of transitory computer-readable media which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in various embodiments, B alone may be present in various embodiments, C alone may be present in various embodiments, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
performing, by a computer-based system for securely processing a transaction, a three factor authentication;
communicating, by the computer-based system and to a web client, a token in response to a transaction request and the three factor authentication;
comparing, by the computer-based system, the token to a received token; and
authorizing, by the computer-based system, the transaction request based upon the comparing.

2. The method of claim 1, wherein the three factor authentication comprises:
authenticating, by the computer-based system, the web client to a transaction account associated with an individual;
authenticating, by the computer-based system, the web client to a payment network associated with the transaction account; and
authenticating, by the computer-based system, the individual to the transaction account based upon a biometric sample.

3. The method of claim 1, further comprising receiving, by the computer-based system, the received token from a merchant.

4. The method of claim 1, further comprising communicating, by the computer-based system, the token in combination with at least one of: a timestamp indicating a time at which the token was generated and a timestamp indicating a time at which the token expires.

5. The method of claim 1, further comprising declining, by the computer-based system, the transaction request based upon a timestamp associated with the token.

6. The method of claim 1, further comprising generating, by the computer-based system, the token in response to the three factor authentication and the transaction request.

7. The method of claim 1, wherein the token comprises at least one of: an alias transaction account number, a unique number, a non-unique number, a QR code, a bar code, and a random number.

8. A system comprising:
a processor for securely processing a transaction;
a tangible, non-transitory memory communicating with the processor;
the tangible, non-transitory memory having instructions stored thereon that, in response to execution by the processor, cause the processor to perform operations comprising:
performing, by the processor, a three factor authentication;
communicating, by the processor and to a web client, a token in response to a transaction request and the three factor authentication;
comparing, by the processor, the token to a received token; and
authorizing, by the processor, the transaction request based upon the comparing.

9. The system of claim 8, wherein the three factor authentication comprises:
authenticating, by the processor, the web client to a transaction account associated with an individual;
authenticating, by the processor, the web client to a payment network associated with the transaction account; and
authenticating, by the processor, the individual to the transaction account based upon a biometric sample.

10. The system of claim 8, further comprising receiving, by the processor, the received token from a merchant.

11. The system of claim 8, further comprising communicating, by the processor, the token in combination with at least one of: a timestamp indicating a time at which the token was generated and a timestamp indicating a time at which the token expires.

12. The system of claim 8, further comprising declining, by the processor, the transaction request based upon a timestamp associated with the token.

13. The system of claim 8, further comprising generating, by the processor, the token in response to the three factor authentication and the transaction request.

14. The system of claim 8, wherein the token comprises at least one of: an alias transaction account number, a unique number, a non-unique number, a QR code, a bar code, and a random number.

15. An article of manufacture including a non-transitory, tangible computer readable medium having instructions stored thereon that, in response to execution by a computer-based system for securely processing a transaction, cause the computer-based system to perform operations comprising:
performing, by the computer-based system, a three factor authentication;
communicating, by the computer-based system and to a web client, a token in response to a transaction request and the three factor authentication;
comparing, by the computer-based system, the token to a received token; and
authorizing, by the computer-based system, the transaction request based upon the comparing.

16. The article of claim 15, wherein the three factor authentication comprises:
authenticating, by the computer-based system, the web client to a transaction account associated with an individual;
authenticating, by the computer-based system, the web client to a payment network associated with the transaction account; and
authenticating, by the computer-based system, the individual to the transaction account based upon a biometric sample.

17. The article of claim 15, further comprising receiving, by the computer-based system, the received token from a merchant.

18. The article of claim 15, further comprising communicating, by the computer-based system, the token in combination with at least one of: a timestamp indicating a time at which the token was generated and a timestamp indicating a time at which the token expires.

19. The article of claim 15, further comprising declining, by the computer-based system, the transaction request based upon a timestamp associated with the token.

20. The article of claim 15, wherein the token comprises at least one of: an alias transaction account number, a unique number, a non-unique number, a QR code, a bar code, and a random number.
